(19) United States
(12) Patent Application Publication
(10) Pub. No.: US 2011/0134833 A1
(43) Pub. Date: Jun. 9, 2011

(54) CONTROLLING ACCESS POINT FUNCTIONALITY

(75) Inventor: Aleksandar M. Gogic, San Diego, CA (US)

(73) Assignee: QUALCOMM Incorporated, San Diego, CA (US)

(21) Appl. No.: 12/633,627

(22) Filed: Dec. 8, 2009

(51) Int. Cl. H04W 64/00

(52) U.S. Cl. 370/328

(57) ABSTRACT

Wireless transmission and/or other functions of an access point (e.g., a femto access point) are controlled based on whether an access terminal is in the vicinity of the access point. For example, wireless transmission may be enabled or disabled based on whether an authorized access terminal is inside or outside a perimeter associated with the access point. An access terminal may send a message to control wireless transmission and/or other functions of the access point based on signals (e.g., pilot signals) the access terminal receives from other access points. For example, the access terminal may determine whether it is inside or outside the perimeter based on comparison of phase information derived from received macro pilot signals with phase information maintained at the access terminal.

### BACKGROUND

1. Field

This application relates generally to wireless communication and more specifically, but not exclusively, to controlling functionality of an access point.

2. Introduction

Wireless communication systems are widely deployed to provide various types of communication to multiple users. For example, voice, data, multimedia services, etc., may be provided to users' access terminals (e.g., cell phones). As the demand for high-rate and multimedia data services rapidly grows, there lies a challenge to implement efficient and robust communication systems with enhanced performance.

To supplement conventional mobile phone network access points (e.g., macro access points), small-coverage access points may be deployed to provide more robust indoor wireless coverage to access terminals. Such small-coverage access points are generally known as access point base stations, Home NodeBs, Home eNodeBs, femto access points, or femto cells. Typically, such small-coverage access points (e.g., installed in a user's home) are connected to the Internet and the mobile operator's network via a DSL router or a cable modem.

In a system that employs small-coverage access points, an access terminal may normally operate under macro coverage until the access terminal enters the coverage of a small coverage access point that allows access by that access terminal. Accordingly, the access terminal needs to be able to determine when it is in the vicinity of such a small coverage access point so that the access terminal may acquire that access point, and subsequently access the services provided by that access point. One way to facilitate this is to configure the access point to continually transmit pilot signals and configure the access terminal to continually or periodically scan for pilot signals from that access point. However, such a scheme may result in relatively significant power consumption at the access terminal due to the continuous scanning, thereby reducing the battery life of the access terminal. Moreover, such a scheme may cause relatively significant interference in the vicinity of the access point due to the continuous transmission of pilot signals.

### SUMMARY

A summary of sample aspects of the disclosure follows. It should be understood that any reference to the term aspects herein may refer to one or more aspects of the disclosure.

The disclosure relates in some aspects to controlling functionality of an access point. For example, wireless transmission and/or other functions of a femto access point or some other type of access point may be enabled or disabled based on whether an access terminal that is authorized to access the access point is in the vicinity of the access point. In this way, power consumption of the access point and interference potentially caused by the access point may be reduced since the access point may disable wireless transmission when there are no authorized access terminals in the vicinity of the access point.

The disclosure relates in some aspects to a scheme where an access terminal sends a message to control wireless transmission and/or other functions of an access point based on at least one signal the access terminal receives from at least one other access point. For example, an access terminal may determine whether it is inside or outside a perimeter associated with a specified access point (e.g., a femto access point) based on pilot signals the access terminal receives from macro access points. The access terminal may then send a message to the specified access point based on this determination. For example, the access terminal may send a request to enable or disable wireless transmission at the specified access point or the access terminal may send an indication of whether it is inside or outside the perimeter.

In some aspects, an access terminal may determine whether it is inside or outside the perimeter based on comparison of phase information derived from received pilot signals with phase information maintained at the access terminal. For example, the access terminal may maintain a database that specifies mean pilot phase and phase deviation for each macro access point of a set of macro access points in the vicinity of a femto access point. Here, this phase information may indicate the ranges of pilot phases that are expected to be received at the access terminal if the access terminal is inside a perimeter associated with the femto access point. Advantageously, since an access terminal may acquire pilot signals from macro access points during the normal course of operations, the access terminal may determine whether it is inside or outside the perimeter with little or no increase in the power consumption of the access terminal.

### BRIEF DESCRIPTION OF THE DRAWINGS

These and other sample aspects of the disclosure will be described in the detailed description and the appended claims that follow, and in the accompanying drawings, wherein:

FIG. 1 is a simplified block diagram of several sample aspects of a communication system where access point functionality is controlled based on the location of at least one access terminal;

FIGS. 2A, 2B, and 2C are a flowchart of several sample aspects of operations that may be performed to control access point functionality based on the location of at least one access terminal;

FIG. 3 is a simplified block diagram of several sample aspects of components that may be employed in communication nodes;

FIG. 4 is a simplified diagram illustrating a sample perimeter associated with an access point;

FIG. 5 is a flowchart of several sample aspects of operations that may be performed in conjunction with determining a location of an access terminal;

FIG. 6 is a simplified diagram of a sample wireless communication system;

FIG. 7 is a simplified diagram of a sample wireless communication system including femto nodes;

FIG. 8 is a simplified diagram illustrating sample coverage areas for wireless communication;

FIG. 9 is a simplified block diagram of several sample aspects of communication components; and

FIGS. 10-12 are simplified block diagrams of several sample aspects of apparatuses configured to control access point functionality as taught herein.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

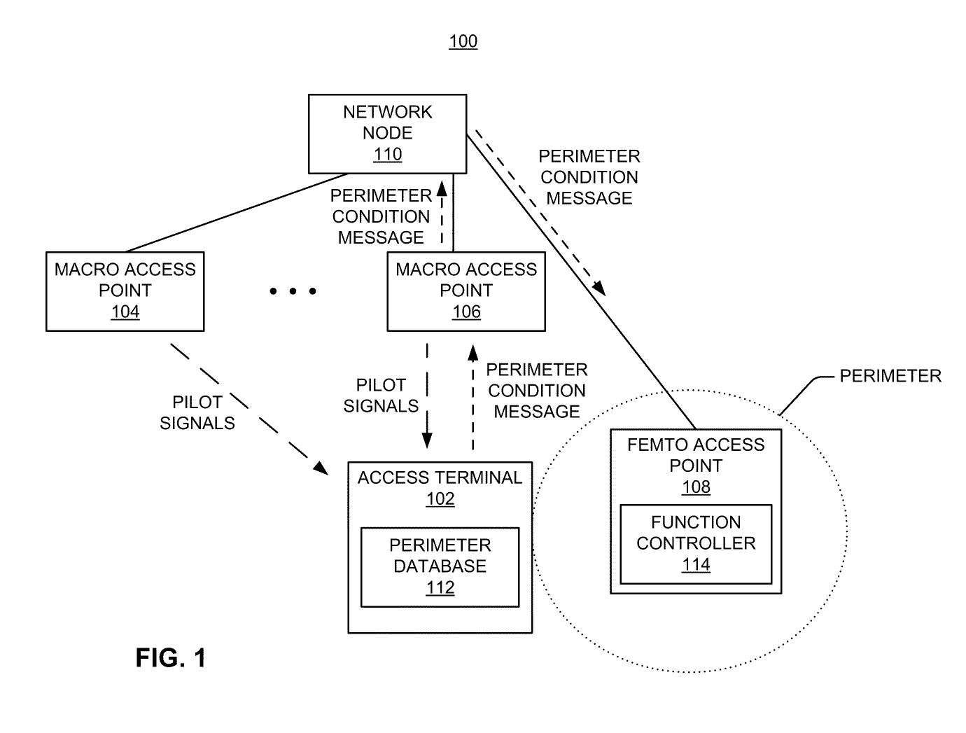

FIG. 1 illustrates several nodes of a sample communication system 100 (e.g., a portion of a communication network). For illustration purposes, various aspects of the disclosure will be described in the context of one or more access terminals, access points, and network nodes that communicate with one another. It should be appreciated, however, that the teachings herein may be applicable to other types of apparatuses or other similar apparatuses that are referenced using other terminology. For example, in various implementations access points may be referred to or implemented as base stations, eNodeBs, and so on, while access terminals may be referred to or implemented as user equipment, mobile stations, and so on.

Access points in the system 100 provide one or more services (e.g., network connectivity) for one or more wireless access terminals that may be installed within or that may roam throughout the coverage area of the system 100. For example, at various points in time the access terminal 102 may connect to one or more access points of a given type (represented by macro access points 104 and 106 and the associated ellipsis) or some other type of access point 108 (e.g., a femto access point). Each of the access points 104, 106, and 108 may communicate with one or more network nodes (represented, for convenience, by network node 110) to facilitate wide area network connectivity. Such network nodes may take various forms such as, for example, one or more radio and/or core network entities. Thus, in various implementations the network node 110 may comprise a network management node (e.g., an operation, administration, management, and provisioning entity), a mobility management entity, or some other suitable network entity. For example, a network management node may perform operations such as provisioning, monitoring, and controlling devices in the network.

In accordance with the teachings herein, the access terminal 102 may send a message to control the access point 108 based on whether the access point 108 is inside or outside a perimeter (represented, in a simplified manner, by the dashed oval) associated with the access point 108. For example, as the access terminal 102 moves throughout the coverage area of the system 100, the access terminal 102 receives signals (e.g., pilot signals) from nearby macro access points. Hence, at different locations in the coverage area, the access terminal 102 will receive signals from different macro access points and/or receive signal with different attributes (e.g., phase information). As discussed in more detail below, by comparing the received signals with information stored in a perimeter database 112 (e.g., a data record stored in a data memory), the access terminal 102 may determined whether it is inside or outside the perimeter. The access terminal 102 may then send a message to control wireless transmission and/or other functions at the access point 108 based on this determination. For example, the access terminal 102 may send a message that is indicative of a determined location condition to the network node 110 via the access point (e.g., access point 106) that is currently serving the access terminal 102. The network node 110, in turn, may send a message that is indicative of the determined location condition to the access point 108. Upon receipt of this message, a function controller 114 of the access point 108 may control wireless transmission and/or some other function(s) of the access point 108. For example, if the access terminal 102 has just moved inside the perimeter, the access point 108 may enable wireless transmission. Conversely, if the access terminal 102 has just moved outside the perimeter (and no other authorized access terminals are within the perimeter), the access point 108 may disable wireless transmission.

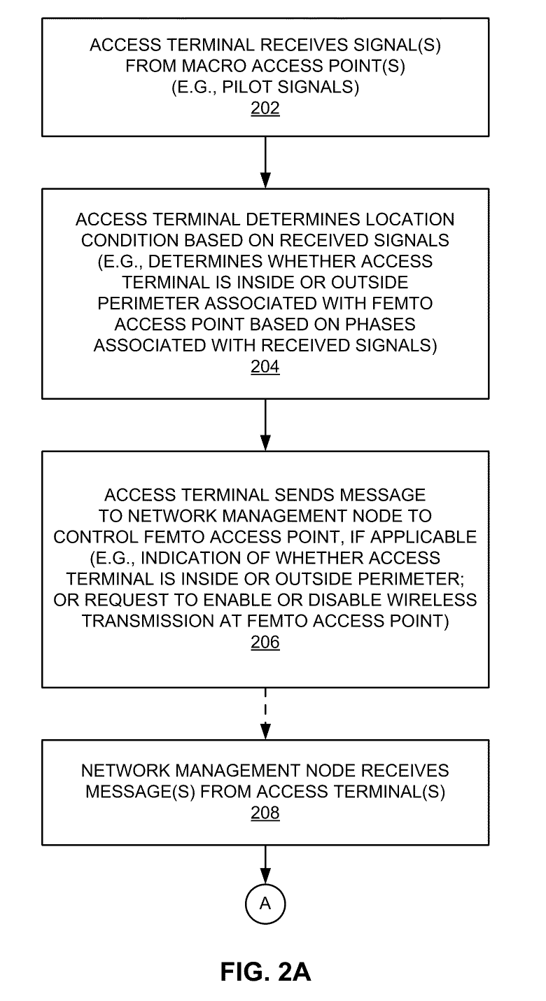

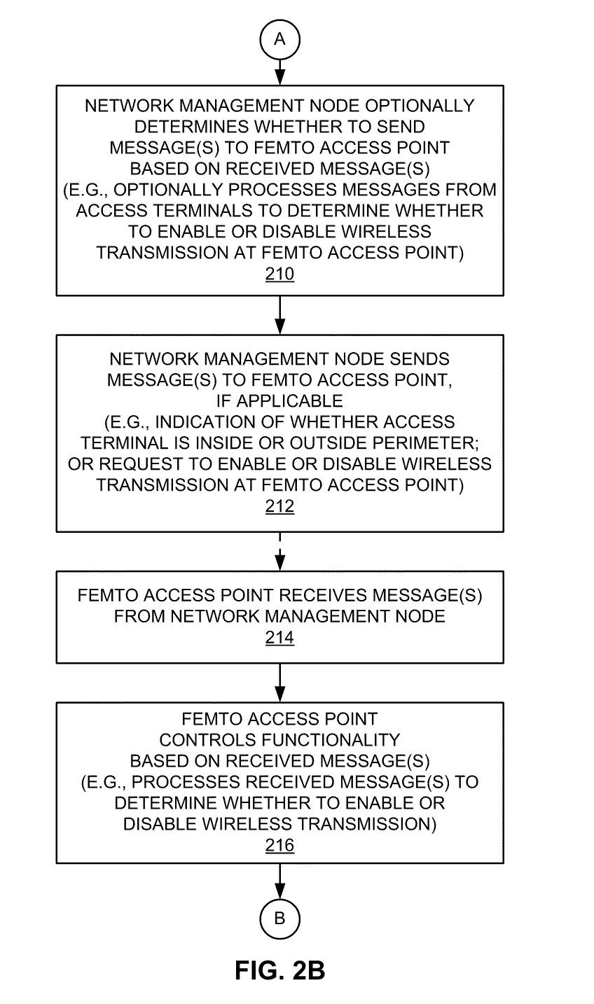

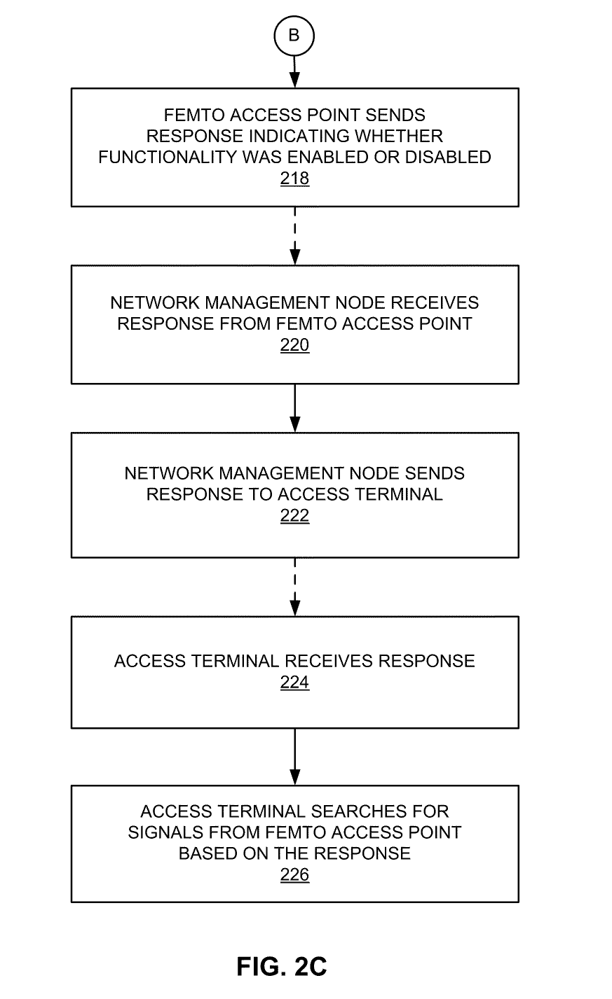

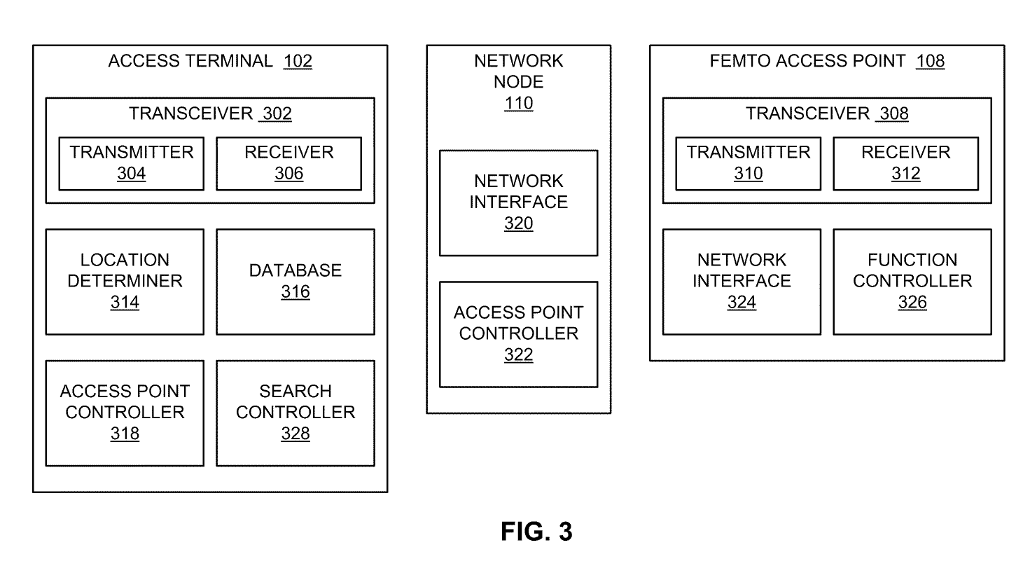

Sample operations of the system 100 will now be described in more detail in conjunction with the flowchart of FIGS. 2A-2C. For convenience, the operations of FIGS. 2A-2C (or any other operations discussed or taught herein) may be described as being performed by specific components. For example, FIG. 3 illustrates various components that may be employed in the access terminal 102, the network node 110, and the access point 108 for performing operations such as those described below. It should be appreciated, however, that the described operations may be performed by other types of components and may be performed using a different number of components. It also should be appreciated that one or more of the operations described herein may not be employed in a given implementation.

As represented by block 202 of FIG. 2A, the access terminal 102 (e.g., a receiver 306 as shown in FIG. 3) receives one or more signals from one or more access points. For example, in some implementations each access point in a network may transmit pilot signals so that it may be determined whether a given access terminal roaming through the network should be handed-over to that access point. As mentioned above, as the access terminal 102 roams throughout such a network, the access terminal 102 may repeatedly monitor for these pilot signals (e.g., at designated wake-up times) so that the access terminal 102 may always be connected to the access point that provided the best level of service (e.g., best geometry). Accordingly, the signals used to determine whether to control the access point 108 may be acquired during standard operations of the access terminal 102. In other words, relatively few or no additional operations may be performed to acquire the information used to determine whether to control the access point 108. Consequently, such a scheme may have little or no impact on the battery life of the access terminal 102.

The pilot signals may comprise various types of information. For example, the pilot signals from a given macro access point may comprise an identifier (e.g., a pseudorandom sequence that uniquely identifies that access point in a given area) that has been assigned to that macro access point. In addition, the macro access points in the network may transmit their pilot signals in a synchronous manner. For example, a given macro access point may periodically transmit the pseudorandom sequence with respect to a known time reference.

As represented by block 204, the access terminal 102 (e.g., a location determiner 314) determines a location condition of the access terminal 102 relative to the access point 108 based on the signals received at block 202. For example, the access terminal 102 may determine whether it is inside or outside a perimeter associated with the access point 108 by comparing phase information derived from received pilot signals with phase information maintained at the access terminal 102 (e.g., stored in a database 316).

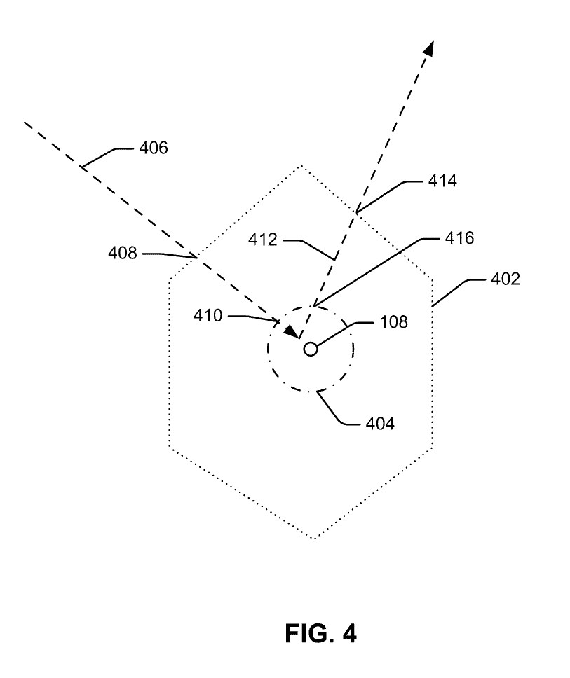

FIG. 4 illustrates a simplified example of a perimeter 402 associated with a femto cell 404 (e.g., corresponding to a coverage area of the femto access point 108). Here, the area covered by the perimeter 402 (e.g., hundreds of meters in width) is larger than the area covered by the femto cell 404 (e.g., typically on the order of 10 to 30 meters in diameter). Accordingly, if the access terminal 102 determines that it is within the perimeter 402, the access terminal 102 may assume that it is in the vicinity of the femto cell 404. Advantageously, this perimeter determination may be made without a high degree of precision if the perimeter 402 is sufficiently larger than the femto cell 404.

In some aspects the perimeter 402 is defined based on macro access point signals expected to be received along the perimeter. For example, there may be a first macro access point to the left of the femto cell 404 that is transmitting pilot signals comprising a first pseudorandom sequence in a synchronous manner. Accordingly, the distance of an access terminal to the first macro access point may be determined based on the phase of the received first pseudorandom sequence at the access terminal. For example, a certain phase value may be expected if the access terminal is at the leftmost boundary of the perimeter 402 while a different phase value may be expected if the access terminal is at the rightmost boundary of the perimeter 402. Similarly, there may be a second macro access point to the upper right of the femto cell 404 that is transmitting pilot signals comprising a second pseudorandom sequence in a synchronous manner. Thus, the distance of an access terminal to the second macro access point may be determined based on the phase of the received second pseudorandom sequence at the access terminal. The access terminal may receive other pseudorandom sequences from other macro access points in a similar manner.

In view of the above, a perimeter around a given femto cell may be defined based on a range of phases and/or other information associated with signals received from each macro access point of a set of one or more access points. In some cases a phase range for a given macro access point may be defined by a phase value (e.g., a mean phase value) and a deviation. In addition, a minimum signal strength may be defined for signals from each macro access point, whereby signals below the minimum signal strength may be ignored by an access terminal when making the determination of block 204. Such signals may be ignored, for example, because they may not provide sufficiently reliable phase information or other information.

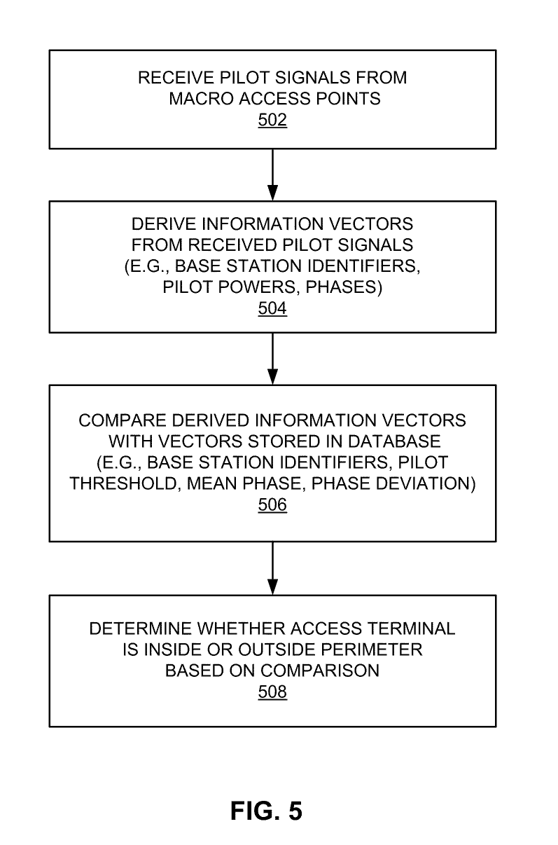

Accordingly, in some implementations the database entries that define a perimeter for a given femto cell may comprise an identifier of the femto access point (e.g., a base station identifier, a pilot identifier, a physical cell identifier, etc.) and, for each macro access point of the set, an identifier of the macro access point (e.g., a base station identifier, a pilot identifier, a physical cell identifier, etc.), a threshold value (e.g., a pilot Ec/Io threshold), a mean phase value (e.g., a mean pilot phase), and a deviation value (e.g., a pilot phase deviation). In such implementations, the operations of block 204 may thus involve comparing corresponding information derived from the received signals with the database entries. Examples of these operations are described in more detail below in conjunction with FIG. 5.

As represented by block 206 of FIG. 2A, the access terminal 102 (e.g., an access point controller 318) may send a message to control the access point 108 based on the determination of block 204. Several examples of conditions under which an access terminal may send such a message will be describe with reference to FIG. 4.

When an access terminal is outside the perimeter 402 and approaching the access point 108 (e.g., along path 406), the access terminal 102 may elect to not send any messages to control the access point 108. For example, it may be of no consequence to the access terminal whether the access point 108 is disabled (e.g., turned-off) or not since the access terminal is too far away to establish wireless communication with the access point 108.

However, at some point in time the access terminal may determine that is has crossed the perimeter (e.g., at point 408) based on analysis of received macro signals. In this case, the access terminal may send a message to enable (e.g., turn-on) certain functionality at the access point 108. In this way, in the event this functionality was disabled, the functionality may be re-enabled so that the access terminal may establish wireless communication with the access point 108 if the access terminal subsequently enters the femto cell 404 (e.g., at point 410). These latter operations are described in more detail below in conjunction with block 226.

In the event the access terminal is inside the perimeter 402 and then follows a path (e.g., path 412) that causes the access terminal to exit the perimeter 402 (e.g., at point 414), the access terminal may send a message to disable certain functionality at the access point 108. For example, in this case, a component (e.g., a transmitter) of the access point 108 may be turned-off or disabled in some other way (e.g., by setting transmit power to zero). Here, since the access terminal is moving away from the access point 108, it may be assumed that the access point 108 may not be conducting wireless communication with the access point 108 in the immediate future. Accordingly, power consumption at the access point 108 and interference caused by transmissions from the access point 108 may be advantageously reduced in this case by disabling this functionality.

The message from an access terminal may take various forms. In some aspects, the message is indicative of a location condition of the access terminal relative to a target access point. For example, in some cases the access terminal may send a message including an explicit indication that the access terminal is inside or outside the perimeter 402. In some cases the access terminal may send a message (e.g., a command) requesting the access point 108 to enable or disable certain functionality (thereby implicitly indicating the location condition of the access terminal).

An access terminal may send the message in various ways as well. For example, the access terminal 102 may send a message to the network node 110 (e.g., a network management node) via the access point that is currently serving the access terminal 102. As discussed in more detail below, in some cases the network node 110 may determine whether to send a message to the access point 108 based on the message received from the access terminal. In addition, in other cases the network node 110 may simply forward the message from the access terminal 102 to the access point 108.

In some implementations a registration message sent by an access terminal may provide an indication of a location condition of the access terminal relative to a target access point. For example, referring to FIG. 4, the access terminal may register on the access point 108 as the access terminal enters the cell 404 (e.g., near point 410). Conversely, the access terminal may register on the macro network as the access terminal is handed out to the macro network (e.g., near point 416). In the latter case, the macro network may then send a corresponding message to the access point 108 (e.g., in the form of an indication that the registration has occurred or an explicit request to disable transmission). Thus, the registration on the macro network may be used to indicate that the access terminal will be leaving the perimeter 402. Consequently, the registration may serve as a substitute for sending an explicit message indicating that the access terminal is leaving the perimeter 402. Access terminal power may thus be saved since the access terminal need not send these explicit messages. The access point 108 may delay turning off its transmitter for a period of time to preclude ping-ponging between enabling and disabling transmission (e.g., employ hysteresis to account for the access terminal remaining in the perimeter for the period of time). In this case, if the access terminal lingers within the perimeter 402 for longer than the period of time (e.g., a defined hysteresis delay time), the access terminal may send a message indicating that it is still within the perimeter 402 so that the access point 108 does not turn off its transmitter.

In some cases the access terminal may delay for a period of time before sending the message. For example, to conserve access terminal power and/or reduce access terminal transmissions, an access terminal may wait until some other type of message is to be sent (e.g., wait for up to a defined maximum period of time), and then send these message together if desired. Also, a form of hysteresis may be employed whereby an access terminal must be inside or outside the perimeter for a period of time before a message is sent. In this way, an access terminal traveling along the perimeter 402 may not repeatedly send messages as it briefly enters and exits the perimeter 402 again and again.

The operations described above may be performed by one or more access terminals. For example, several access terminals may be authorized to access a given femto access point. Accordingly, a decision to disable functionality at the access point may depend on whether all access terminals that are allowed to access the access point are outside the perimeter. As discussed below, in various implementations this decision may be made by a network node or the access point.

As represented by block 208, the network node 110 (e.g., a network interface 320) may thus receive one or more messages from one or more access terminals (e.g., via one or more access points). In practice, the network node 110 may handle messages relating to multiple access points (e.g., femto access points). Hence, the network node 110 may process messages directed to different access points separately to independently control each of these access points. For purposes of illustration, the remaining operations of FIGS. 2B and 2C are directed to the control of a given access point.

As represented by blocks 210 and 212, the network node 110 (e.g., an access point controller 322) may optionally determine whether to send one or more messages to the access point 108. As mentioned above, in some implementations the network node 110 may simply send the location condition message(s) it receives from the access terminal(s) to the access point 108, while in other implementations the network node 110 may determine whether to send a message to the access point 108 based on the received message(s). In either case, the network node 110 may authenticate a received message to verify that the access terminal that sent the message is authorized to control the access points 108. In some cases, authorization to control the access point 108 may be indicated by the access terminal being authorized to access the access point 108.

As an example of the above, if the network node 110 receives an indication that an access terminal has recently entered the perimeter 402, the network node 110 (e.g., the access point controller 322) may send a message requesting the access point 108 to enable certain functionality. Here, the network node 110 may optionally keep track of the current state (e.g., enabled or disabled) of the access point 108 to avoid sending unnecessary (e.g., redundant) messages.

As another example, the network node 110 may maintain information regarding multiple access terminals (e.g., those access terminals that are authorized to access the access point 108) to determine whether to send a message to the access point 108. For example, the network node 110 may keep track of the state of the access terminals (e.g., whether the access terminals are inside or outside the perimeter 402) or may keep track of the messages received from the access terminals. Based on this information, the network node 110 (e.g., the access point controller 322) may elect to not send a message or may send a message to cause the access point 108 to enable or disable functionality.

As a specific example, in the event the network node 110 receives a message from an access terminal that indicates (e.g., explicitly or implicitly) that functionality of the access point 108 should be disabled, the network node 110 may determine whether this condition is met for all access terminals that may access the access points 108. If this condition is not met, the network node 108 may elect to not send a message to the access point 108. Conversely, if this condition is met, the network node 108 may send a message to the access point 108 requesting that the functionality be disabled.

Here, the manner in which it is determined whether the condition is met will depend on the type of access terminal information maintained by the network node. For example, in some cases the network node 110 may determine whether there is at least one access terminal inside the perimeter 402 (e.g., based on messages from the access terminals that indicate whether they are inside or outside the perimeter 402). In some cases, the network node 110 may keep track of the requests received from the access terminals. For example, in one scenario the network node 110 may have received a request to enable functionality of the access point 108 from an access terminal, but not yet received a request to disable the functionality from that same access terminal (e.g., because the access terminal is still inside the perimeter). In this case, if the network node receives a request to disable the functionality of the access point 108 from a different access terminal, the network node 110 may elect to not send a message to the access point 108 requesting that this functionality be disabled.

In some cases, the network node 110 may override (e.g., overrule) the capability of an access terminal to control the access point 108. For example, a wireless network operator may elect to overrule access terminal control in the event of a calamity (e.g., an earthquake) or some other circumstances. In this way, the network operator may, for example, maximize capacity and robustness of the network as a whole when such factors are of prime importance. Accordingly, in some aspects the determination of block 210 regarding whether to send a message to the access point 108 may involve, for example, determining whether to override a request to enable or disable wireless transmission from an access terminal. In some cases, this determination may be based on a criterion specified by the network operator (e.g., override if a certain event occurs).

As described above, the message from the network node 110 may take various forms. Again, in some aspects, the message is indicative of a location condition of the access terminal relative to an access point. For example, in some cases the message comprises an explicit indication that the access terminal is inside or outside the perimeter 402 while in other cases the message comprises a request that the access point 108 enable or disable certain functionality.

As represented by block 214, the access point 108 (e.g., a network interface 324) may thus receive one or more messages from the network node 110. As discussed above, the access point 108 may receive a single message originating from a single access terminal (e.g., as forwarded by the network node 110), a single message from the network node 110 (e.g., a request based on the determination of block 210), or multiple messages from multiple access terminals (e.g., as forwarded by the network node 110).

As represented by block 216, the access point 108 (e.g., a function controller 326) processes the received message(s) to determine whether to control wireless transmission and/or some other function. As discussed herein, the access point 108 may enable (e.g., turn-on) functionality if one or more received messages indicates that at least one access terminal is inside the perimeter 204 or if one or more received messages requests that the functionality be enabled. Conversely, the access point 108 may disable (e.g., turn-off) functionality if one or more received messages requests that the functionality be disabled or indicates that at least one access terminal is now outside the perimeter 204. In this latter case, the access point 108 may maintain information regarding the state of access terminals (e.g., authorized access terminals) or previously received messages, and condition the disabling of the functionality based on this information. For example, the access point 108 may only disable the functionality if there are no access terminals requesting the functionality and/or if there are no access terminals inside the perimeter 402.

Controlling the access point 108 may involve different operations in different implementations. For example, in some cases this may involve disabling one or more components of the wireless transceiver 308 (e.g., the transmitter 310). In some cases this may involve disabling wireless communication protocol operations. In some cases this may involve powering-down one or more components and/or disabling one or more clock signals. Also, more than one of the above operations may be performed in some cases.

As represented by block 218, the access point 108 (e.g., the function controller 326) may send a response indicating whether functionality was enabled or disabled at block 216. For example, the access point 108 may send a message (indicating that wireless transmission was enabled) to each access terminal that sent a request or that sent an indication that it was inside the perimeter 402.

As represented by blocks 220 and 222, upon receipt of the response(s) from the access point 108, the network node 110 (e.g., the network interface 320) may send a response to one or more access terminals. For example, the network node may send a message indicating that wireless transmission was enabled to each access terminal that sent a request to the network node 110 or that sent an indication to the network node 110 indicating that that access terminal is inside the perimeter 402.

As represented by block 224, the access terminal 102 (e.g., the receiver 306) may thus receive a response indicating whether wireless transmission and/or some other functionality has been enabled or disabled at the access point 108. As represented by block 226, in some cases the access terminal 102 (e.g., a search controller 328) may use the receipt of this response as a trigger to commence a search for signals from the access point 108. For example, during idle mode, the access terminal 102 may wake-up at designated intervals to search for pilot signals on the carrier frequency (e.g., corresponding to a femto channel) used by the access point 108. The access terminal 102 may continue to search for these pilot signals as long as the access terminal 102 is inside the perimeter 402. In some implementations the search may involve taking a sample segment of a CDMA signal and conducting a pilot search for the pilot PN offset used by the access point 108. It should be appreciated that different types of pilot signals or other signals may be employed in different implementations.

In the event the access terminal 102 gets close enough to the access point 108 to receive the pilot signals (e.g., within the femto cell 404), the access terminal 102 may be handed-over to the access point 108. In some cases, this handover operation may involve verifying that the access terminal 102 is authorized to access the access point 108. When the access terminal 102 eventually leaves the coverage of the femto cell 404, the access terminal 102 may re-register with the macro network so that the access terminal may be served by a nearby macro access point.

The access terminal 102 may continue monitoring for macro pilot signals during any of the above operations. Hence, the access terminal 102 may send another message if there is any change in the location condition of the access terminal 102. For example, if the access terminal 102 had entered the perimeter 402 at block 204, and upon receipt of a new set of signals (upon repeating the operations of block 202) the access terminal 102 determines that its has exited the perimeter 402 (upon repeating the operations of block 204), the access terminal 102 may send another message indicative of this new location condition. As discussed above, this may cause the access point 108 to turn-off its transmitter. The access terminal 102 may then return to monitoring the macro carrier frequency or frequencies.

Other types of triggers may be employed at an access terminal to determine whether to send a message to control an access point. For example, if an access terminal is being disabled (e.g., turned-off), the access terminal may send a message requesting that certain functionality of the access point be disabled (e.g., transmitter turned off). In this case, when the access terminal is enabled (e.g., turned-on), the access terminal may send a message requesting that the functionality point be enabled (e.g., if the location conditions are met as well).

As mentioned above, FIG. 3 illustrates several sample components that may be incorporated into nodes such as the access terminal 102, the access point 108, and the network node 110 to perform access point control operations as taught herein. The described components may be incorporated into other nodes (e.g., access terminals, access points, and core network nodes) in a communication system. Also, a given node may contain one or more of the described components. For example, a node may contain multiple transceiver components that enable the node to operate on multiple frequencies and/or communicate via different technologies.

As shown in FIG. 3, the access terminal 102, the access point 108, and the network node 110 include various components for communicating with other nodes. For example, the access terminal 102 may include a transceiver 302 for communicating with wireless nodes. The transceiver 302 includes a transmitter 304 for sending signals (e.g., perimeter condition messages) and a receiver 306 for receiving signals (e.g., pilot signals and responses). The access point 108 also may include a transceiver 308 for communicating with wireless nodes. The transceiver 308 includes a transmitter 310 for sending signals (e.g., pilot signals and responses) and a receiver 312 for receiving signals (e.g., perimeter condition messages). The access point 108 and the network node 110 may include network interfaces 324 and 320, respectively, for communicating with other network nodes (e.g., sending and receiving messages and responses). For example, the network interfaces 320 and 324 may be configured to communicate via wired or wireless connections to provide backhaul communication and other types of communication to facilitate communication with each other and with other core network nodes.

The access terminal 102, the access point 108, and the network node 110 also include other components that may be used in conjunction with access point control operations as taught herein. For example, the access terminal 102 may include a location determiner 314 for determining a location condition of the access terminal (e.g., inside or outside a perimeter) and for providing other related functionality as taught herein. In addition, the access terminal 102 may include a database 316 (e.g., corresponding to database 112) for storing location-related vector information and for providing other related functionality as taught herein. The access terminal 102 also may include an access point controller 318 for determining whether to send location condition messages, for sending these messages, and for providing other related functionality as taught herein. Furthermore, the access terminal 102 may include a search controller 328 for conducting searches for signals (e.g., pilot signals) and for providing other related functionality as taught herein. The access point 108 may include a function controller 326 (e.g., a wireless transmission controller corresponding to controller 114) for controlling functionality of the access point 108 and for providing other related functionality as taught herein. The network node 110 may include an access point controller 322 for determining whether to send location condition messages, for sending these messages, and for providing other related functionality as taught herein.

Referring now to FIG. 5, sample operations relating to using a database (e.g., database 316) to determine whether an access terminal is inside a perimeter associated with an access point will be described in more detail. For purposes of illustration, these operations are described in the context of a scenario where the access terminal 102 maintains a database that includes a set of vectors that specify information about macro access points in the vicinity of a given femto access point. In some cases the database may include records for more that one femto access point (e.g., femto access points for different homes). In these cases, the database may include different sets of vectors for these different femto access points. It should be appreciated that the teachings herein may be applicable to other types of access points as well (e.g., a wireless local area network, such as Wi-Fi).

Briefly, in some implementations, each entry of the database circumscribes a femto cell location in a non-orthogonal coordinate system comprised of macro pilots visible at that femto location (with qualifying minimum Ec/Io), the phase delay of each pilot, and allowed deviation around that nominal phase delay. In some aspects, the database may be used to gate femto control and femto searching. For example, the access terminal 102 may generally operate on a macro frequency, and only conduct searches on a femto frequency when there is a database match. In some implementations, the database elements include macro pilot PN offsets, which are all visible by the access terminal 102 on whatever carrier it is monitoring in the idle state. These PN offsets are accessible to the access terminal 102 in the course of routine operation in idle state, and the access terminal 102 may not need to do anything different until there is a database match. Once there is a database match, the access terminal 102 may send a message to enable wireless transmission at the femto cell, then commence scanning for the femto cell (e.g., on a different frequency).

In some aspects, the location of a femto cell is described by means of primitives comprised of macro system parameters: within the area described by a set of macro access points, in which the pilot signals from the access points exceed a designated threshold Ec/Io, and have a given phase within a given tolerance. Here, a first vector identifies the set of macro access points, a second vector describes different thresholds for the pilot signals from different access point, a third vector describes different expected phase values (e.g., mean phase) for the pilot signals at the access terminal 102, and a fourth vector describes an expected (e.g., acceptable) deviation for the phase values for each of the pilot signals. Advantageously, these parameters may be measured with little or no change of signal processing procedures (e.g., CDMA procedures in idle or active state). Hence, this operation may be performed with minimal or no effect in terms of battery life and/or network use (e.g., as compared to A-GPS geo-location procedures or other similar alternative procedures).

In some implementations, the database contains the following information for each femto cell (i.e., each femto access point): (1) FEMTO_ORD—Ordinal number of the access terminal's database entry. The first entry may be reserved for that access terminal's home femto cell; (2) FEMTO_BAND_CLASS—Band class where femto cells are deployed; (3) FEMTO_CHAN—Channel number where the femto cell is deployed; (4) FEMTO_SID—System ID for the femto cell; (5) FEMTO_NID—Network ID for the femto cell; FEMTO_TYPE—Radio technology used by the femto cell; (6) FEMTO_BASE_ID—Base station identity (BASE_ID) broadcast in the femto cell system parameters message (SPM); (7) FEMTO_LAT—Base station latitude (BASE_LAT) broadcast in the femto cell SPM; (8) FEMTO_LONG—Base station longitude (BASE_LONG) broadcast in the femto cell SPM; (9) FEMTO_PN—Pilot PN offset used by this femto cell; (10) MACRO_SID—SID of the macro system around the femto; (11) MACRO_NID—NID of the macro system around the femto; (12) MACRO_BASE_ID—BASE_ID of the “mother cell”, where “mother cell” is the macro cell the access terminal is connected to in the idle state, when within the coverage area of the femto cell; (13) MACRO_BASE_LAT—Latitude of the “mother cell”; (14) MACRO_BASE_LONG—Longitude of the “mother cell”; (15) MACRO_PN_VECTOR—Set of phase vectors for the macro pilots near the femto cell. As discussed herein, by using this phase vector set, the access terminal may gauge proximity to the femto cell; (16) Access time, acquisition date/time counters. This information may be used to rank entries in the database and drop off infrequently and/or not-recently used entries (e.g., when the access terminal runs low on memory allocated to database).

The database may be created in various ways. In some cases, the database entries for a given access point may be created when the access terminal 102 is activated (e.g., first authorized) for use at that access point. In some cases, the access terminal 102 may monitor for signals from femto and macro access points, and build the database based on the monitored signals.

As represented by block 502 of FIG. 5, the access terminal 102 receives pilot signals from several nearby macro access points on one or more carrier frequencies used by macro access points. As mentioned above, these signals may be received during the course of standard monitoring operations performed by the access terminal 102. Accordingly, the acquisition of these signals may have little or no impact on the resources of the access terminal 102.

As represented by block 504, the access terminal 102 derives information from each of the received pilot signals. For example, as discussed above, the access terminal 102 may extract information such as the SID, NID, and BASE_ID included in a given pilot signal. In addition, the access terminal 102 may derive the phase delay that is indicative of how long it took the pilot signal to travel from the corresponding macro access point to the access terminal 102. In some implementations this may involve determining a phase delay associated with a synchronously transmitted PN sequence. Furthermore, the access terminal 102 may measure one or more power characteristics of each received pilot signal. For example, the access terminal 102 may measure pilot power expressed as chip energy to total interference ratio (Ec/Io).

As represented by block 506, the access terminal 102 compares the information derived at block 504 with the vector information stored in the database. For example, for each macro access point specified by the vector information, the access terminal 102 may determine whether there is a match between the derived MACRO_SID and the SID of the macro access point around the femto cell as specified by the database, between the derived MACRO_NID and the NID of the macro access point around the femto cell as specified by the database, and between the derived MACRO_BASE_ID and an identifier (e.g., base station identifier) of a macro access point specified by the database. The access terminal 102 also may compare the power (e.g., Ec/Io) of the received pilot signal with the corresponding threshold from the database. In addition (e.g., if there are matches between the above quantities), the access terminal 102 may compare a derived MACRO_PN_VECTOR with the mean phase and phase deviation information specified by the database.

As represented by block 508, the access terminal 102 may then determine whether it is inside or outside the perimeter 402 based on the comparison of block 506. For example, if the derived phase vector falls within the deviation around the mean phase, the access terminal 102 may be deemed to be inside the perimeter 402. The access terminal may then send a message and commence searching for pilot signals from the femto cell as described above. On the other hand, if any of the comparisons of block 506 fail, the access terminal 102 may be deemed to be outside the perimeter 402. In this case, the access terminal 102 may continue monitoring the macro carrier frequency or frequencies.

It should be appreciated that various techniques may be employed for determining whether an access terminal is in the vicinity of an access point in accordance with the teachings herein. For example, advanced forward link trilateration (AFLT) techniques or other suitable techniques (e.g., based on triangulation, trilateration, or some other algorithm) may be employed in different implementations. Also, finding the approximate location of a femto cell may be improved in cases where there are bad geometries (e.g., a case when the access terminal is in a location dominated by a single access point, whereby other access points are difficult to detect) through the use of highly detectable pilots defined for certain radio technologies.

As discussed above, the teachings herein may be employed in a network that includes macro scale coverage (e.g., a large area cellular network such as a 3G network, typically referred to as a macro cell network or a WAN—wide area network) and smaller scale coverage (e.g., a residence-based or building-based network environment, typically referred to as a LAN—local area network). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

A node (e.g., an access point) that provides coverage over a relatively large area may be referred to as a macro node while a node that provides coverage over a relatively small area (e.g., a residence) may be referred to as a femto node. It should be appreciated that the teachings herein may be applicable to nodes associated with other types of coverage areas. For example, a pico node may provide coverage (e.g., coverage within a commercial building) over an area that is smaller than a macro area and larger than a femto area. In various applications, other terminology may be used to reference a macro node, a femto node, or other access point-type nodes. For example, a macro node may be configured or referred to as an access node, base station, access point, nodeB, eNodeB, macro cell, and so on. Also, a femto node may be configured or referred to as a Home NodeB, Home eNodeB, access point base station, femto cell, and so on. In some implementations, a node may be associated with (e.g., divided into) one or more cells or sectors. A cell or sector associated with a macro node, a femto node, or a pico node may be referred to as a macro cell, a femto cell, or a pico cell, respectively.

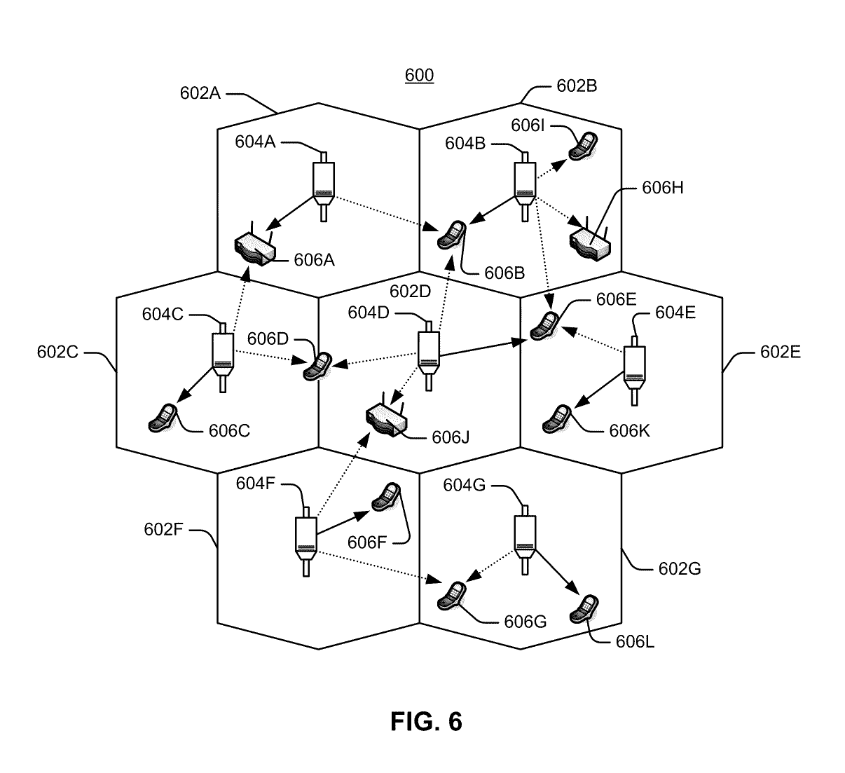

FIG. 6 illustrates a wireless communication system 600, configured to support a number of users, in which the teachings herein may be implemented. The system 600 provides communication for multiple cells 602, such as, for example, macro cells 602A-602G, with each cell being serviced by a corresponding access point 604 (e.g., access points 604A-604G). As shown in FIG. 6, access terminals 606 (e.g., access terminals 606A-606L) may be dispersed at various locations throughout the system over time. Each access terminal 606 may communicate with one or more access points 604 on a forward link (FL) and/or a reverse link (RL) at a given moment, depending upon whether the access terminal 606 is active and whether it is in soft handoff, for example. The wireless communication system 600 may provide service over a large geographic region. For example, macro cells 602A-602G may cover a few blocks in a neighborhood or several miles in rural environment.

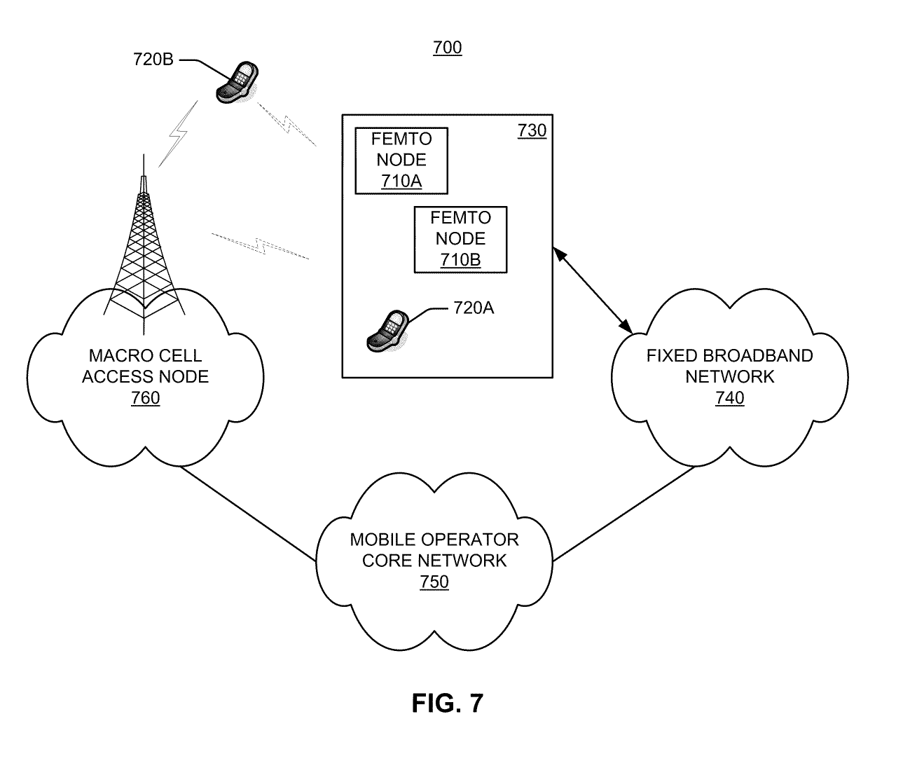

FIG. 7 illustrates an exemplary communication system 700 where one or more femto nodes are deployed within a network environment. Specifically, the system 700 includes multiple femto nodes 710 (e.g., femto nodes 710A and 710B) installed in a relatively small scale network environment (e.g., in one or more user residences 730). Each femto node 710 may be coupled to a fixed broadband network 740 (e.g., via a DSL router, a cable modem, a wireless link, or other connectivity means) and a mobile operator core network 750. As will be discussed below, each femto node 710 may be configured to serve associated access terminals 720 (e.g., access terminal 720A) and, optionally, other (e.g., hybrid or alien) access terminals 720 (e.g., access terminal 720B). In other words, access to femto nodes 710 may be restricted whereby a given access terminal 720 may be served by a set of designated (e.g., home) femto node(s) 710 but may not be served by any non-designated femto nodes 710 (e.g., a neighbor's femto node 710).

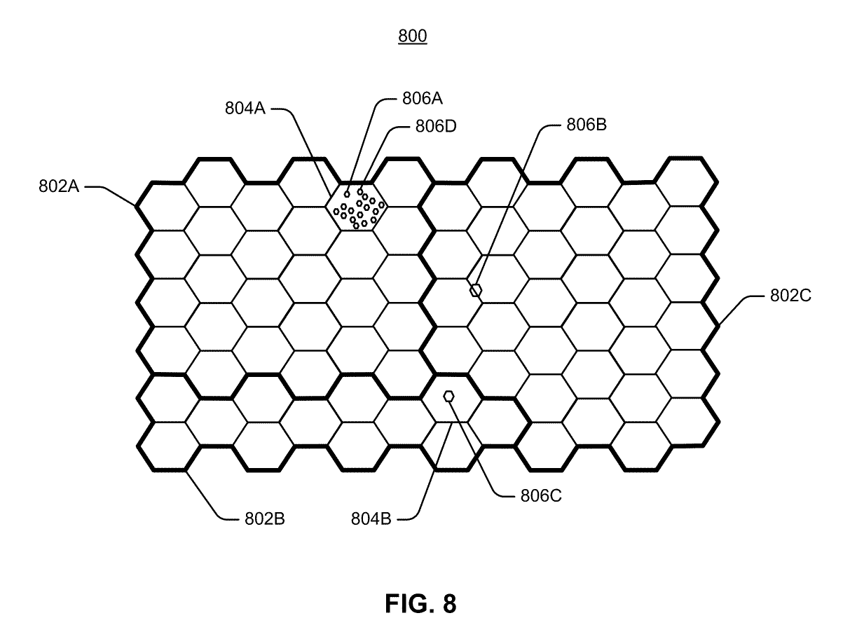

FIG. 8 illustrates an example of a coverage map 800 where several tracking areas 802 (or routing areas or location areas) are defined, each of which includes several macro coverage areas 804. Here, areas of coverage associated with tracking areas 802A, 802B, and 802C are delineated by the wide lines and the macro coverage areas 804 are represented by the larger hexagons. The tracking areas 802 also include femto coverage areas 806. In this example, each of the femto coverage areas 806 (e.g., femto coverage areas 806B and 806C) is depicted within one or more macro coverage areas 804 (e.g., macro coverage areas 804A and 804B). It should be appreciated, however, that some or all of a femto coverage area 806 may not lie within a macro coverage area 804. In practice, a large number of femto coverage areas 806 (e.g., femto coverage areas 806A and 806D) may be defined within a given tracking area 802 or macro coverage area 804. Also, one or more pico coverage areas (not shown) may be defined within a given tracking area 802 or macro coverage area 804.

Referring again to FIG. 7, the owner of a femto node 710 may subscribe to mobile service, such as, for example, 3G mobile service, offered through the mobile operator core network 750. In addition, an access terminal 720 may be capable of operating both in macro environments and in smaller scale (e.g., residential) network environments. In other words, depending on the current location of the access terminal 720, the access terminal 720 may be served by a macro cell access point 760 associated with the mobile operator core network 750 or by any one of a set of femto nodes 710 (e.g., the femto nodes 710A and 710B that reside within a corresponding user residence 730). For example, when a subscriber is outside his home, he is served by a standard macro access point (e.g., access point 760) and when the subscriber is at home, he is served by a femto node (e.g., node 710A). Here, a femto node 710 may be backward compatible with legacy access terminals 720.

A femto node 710 may be deployed on a single frequency or, in the alternative, on multiple frequencies. Depending on the particular configuration, the single frequency or one or more of the multiple frequencies may overlap with one or more frequencies used by a macro access point (e.g., access point 760).

In some aspects, an access terminal 720 may be configured to connect to a preferred femto node (e.g., the home femto node of the access terminal 720) whenever such connectivity is possible. For example, whenever the access terminal 720A is within the user's residence 730, it may be desired that the access terminal 720A communicate only with the home femto node 710A or 710B.

In some aspects, if the access terminal 720 operates within the macro cellular network 750 but is not residing on its most preferred network (e.g., as defined in a preferred roaming list), the access terminal 720 may continue to search for the most preferred network (e.g., the preferred femto node 710) using a Better System Reselection (BSR), which may involve a periodic scanning of available systems to determine whether better systems are currently available, and subsequently acquire such preferred systems. The access terminal 720 may limit the search for specific band and channel. For example, one or more femto channels may be defined whereby all femto nodes (or all restricted femto nodes) in a region operate on the femto channel(s). The search for the most preferred system may be repeated periodically. Upon discovery of a preferred femto node 710, the access terminal 720 selects the femto node 710 and registers on it for use when within its coverage area.

Access to a femto node may be restricted in some aspects. For example, a given femto node may only provide certain services to certain access terminals. In deployments with so-called restricted (or closed) access, a given access terminal may only be served by the macro cell mobile network and a defined set of femto nodes (e.g., the femto nodes 710 that reside within the corresponding user residence 730). In some implementations, a node may be restricted to not provide, for at least one node, at least one of: signaling, data access, registration, paging, or service.

In some aspects, a restricted femto node (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., femto nodes) that share a common access control list of access terminals.

Various relationships may thus exist between a given femto node and a given access terminal. For example, from the perspective of an access terminal, an open femto node may refer to a femto node with unrestricted access (e.g., the femto node allows access to any access terminal). A restricted femto node may refer to a femto node that is restricted in some manner (e.g., restricted for access and/or registration). A home femto node may refer to a femto node on which the access terminal is authorized to access and operate on (e.g., permanent access is provided for a defined set of one or more access terminals). A guest femto node may refer to a femto node on which an access terminal is temporarily authorized to access or operate on. An alien femto node may refer to a femto node on which the access terminal is not authorized to access or operate on, except for perhaps emergency situations (e.g., 911 calls).

From a restricted femto node perspective, a home access terminal may refer to an access terminal that is authorized to access the restricted femto node installed in the residence of that access terminal's owner (usually the home access terminal has permanent access to that femto node). A guest access terminal may refer to an access terminal with temporary access to the restricted femto node (e.g., limited based on deadline, time of use, bytes, connection count, or some other criterion or criteria). An alien access terminal may refer to an access terminal that does not have permission to access the restricted femto node, except for perhaps emergency situations, for example, such as 911 calls (e.g., an access terminal that does not have the credentials or permission to register with the restricted femto node).

For convenience, the disclosure herein describes various functionality in the context of a femto node. It should be appreciated, however, that a pico node or some other type of node may provide the same or similar functionality for a different (e.g., larger) coverage area. For example, a pico node may be restricted, a home pico node may be defined for a given access terminal, and so on.

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min {N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

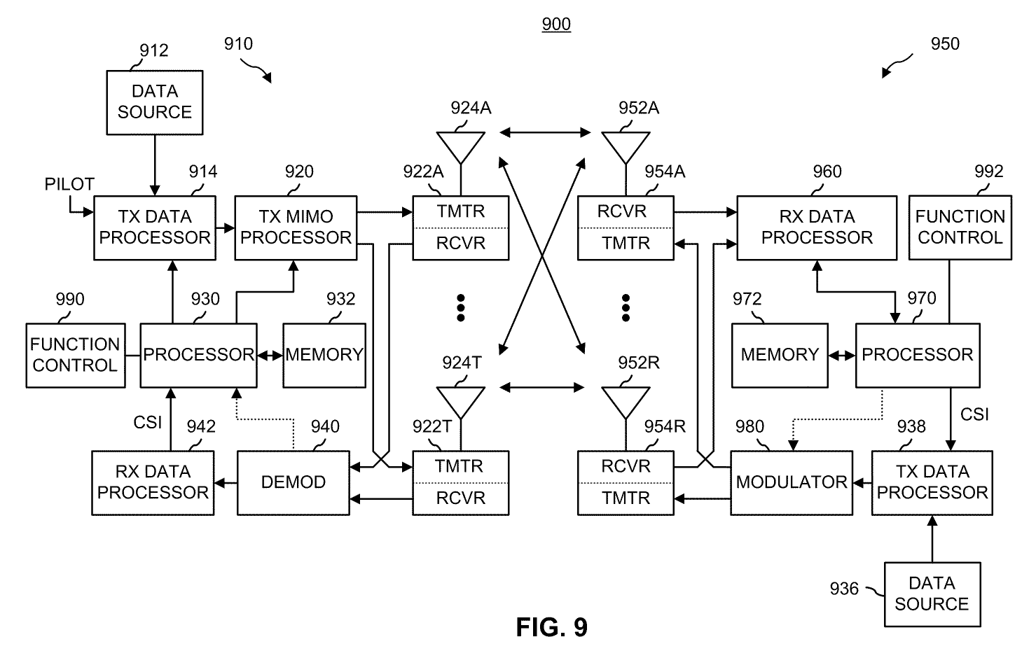

FIG. 9 illustrates a wireless device 910 (e.g., an access point) and a wireless device 950 (e.g., an access terminal) of a sample MIMO system 900. At the device 910, traffic data for a number of data streams is provided from a data source 912 to a transmit (TX) data processor 914. Each data stream may then be transmitted over a respective transmit antenna.

The TX data processor 914 formats, codes, and interleaves the traffic data for each data stream based on a particular coding scheme selected for that data stream to provide coded data. The coded data for each data stream may be multiplexed with pilot data using OFDM or other suitable techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 930. A data memory 932 may store program code, data, and other information used by the processor 930 or other components of the device 910.

The modulation symbols for all data streams are then provided to a TX MIMO processor 920, which may further process the modulation symbols (e.g., for OFDM). The TX MIMO processor 920 then provides N_{T} modulation symbol streams to N_{T} transceivers (XCVR) 922A through 922T. In some aspects, the TX MIMO processor 920 applies beam-forming weights to the symbols of the data streams and to the antenna from which the symbol is being transmitted.

Each transceiver 922 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 922A through 922T are then transmitted from N_{T} antennas 924A through 924T, respectively.

At the device 950, the transmitted modulated signals are received by N_{R} antennas 952A through 952R and the received signal from each antenna 952 is provided to a respective transceiver (XCVR) 954A through 954R. Each transceiver 954 conditions (e.g., filters, amplifies, and downconverts) a respective received signal, digitizes the conditioned signal to provide samples, and further processes the samples to provide a corresponding “received” symbol stream.

A receive (RX) data processor 960 then receives and processes the N_{R} received symbol streams from N_{R} transceivers 954 based on a particular receiver processing technique to provide N_{T} “detected” symbol streams. The RX data processor 960 then demodulates, deinterleaves, and decodes each detected symbol stream to recover the traffic data for the data stream. The processing by the RX data processor 960 is complementary to that performed by the TX MIMO processor 920 and the TX data processor 914 at the device 910.

A processor 970 periodically determines which pre-coding matrix to use (discussed below). The processor 970 formulates a reverse link message comprising a matrix index portion and a rank value portion. A data memory 972 may store program code, data, and other information used by the processor 970 or other components of the device 950.

The reverse link message may comprise various types of information regarding the communication link and/or the received data stream. The reverse link message is then processed by a TX data processor 938, which also receives traffic data for a number of data streams from a data source 936, modulated by a modulator 980, conditioned by the transceivers 954A through 954R, and transmitted back to the device 910.

At the device 910, the modulated signals from the device 950 are received by the antennas 924, conditioned by the transceivers 922, demodulated by a demodulator (DEMOD) 940, and processed by a RX data processor 942 to extract the reverse link message transmitted by the device 950. The processor 930 then determines which pre-coding matrix to use for determining the beam-forming weights then processes the extracted message.

FIG. 9 also illustrates that the communication components may include one or more components that perform function control-related operations as taught herein. For example, a function control component 990 may cooperate with the processor 930 and/or other components of the device 910 to send and/or receive control-related signals (e.g., location condition messages and responses) to and/or from another device (e.g., device 950) as taught herein. Similarly, a function control component 992 may cooperate with the processor 970 and/or other components of the device 950 to send and/or receive control-related signals to and/or from another device (e.g., device 910). It should be appreciated that for each device 910 and 950 the functionality of two or more of the described components may be provided by a single component. For example, a single processing component may provide the functionality of the function control component 990 and the processor 930 and a single processing component may provide the functionality of the function control component 992 and the processor 970.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. Although certain aspects of the disclosure may be described using 3GPP terminology, it is to be understood that the teachings herein may be applied to 3GPP (Re199, Re15, Re16, Re17) technology, as well as 3GPP2 (1xRTT, 1xEV-DO Re10, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

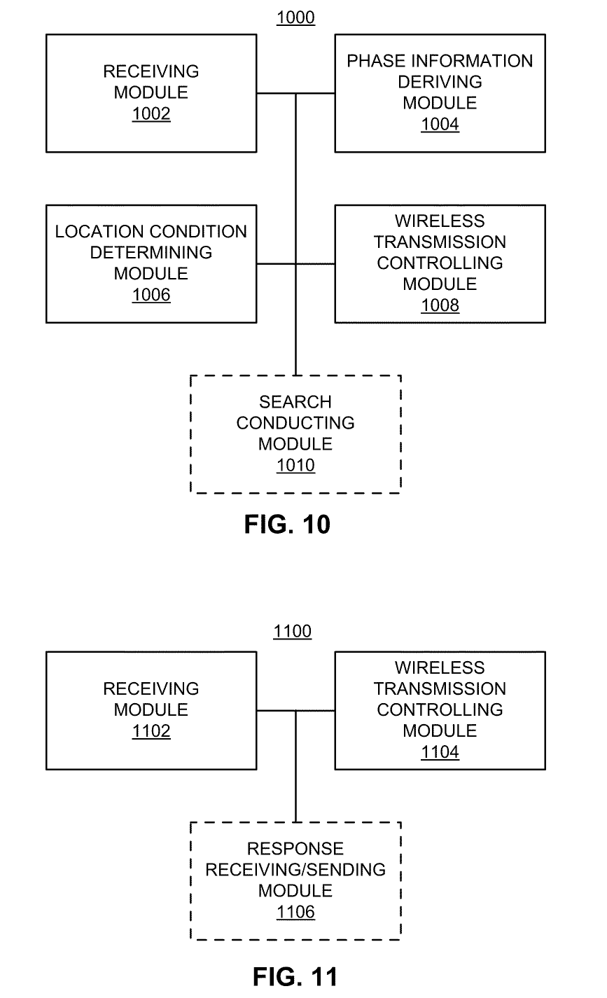

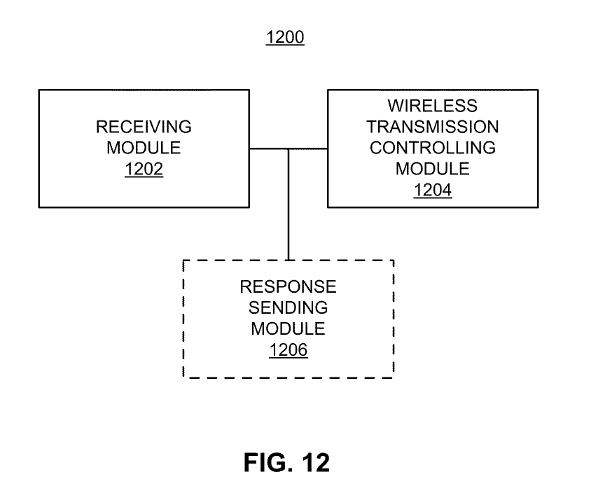

The functionality described herein (e.g., with regard to one or more of the accompanying figures) may correspond in some aspects to similarly designated “means for” functionality in the appended claims. Referring to FIGS. 10-12, apparatuses 1000, 1100, and 1200 are represented as a series of interrelated functional modules. Here, a receiving module 1002 may correspond at least in some aspects to, for example, a receiver as discussed herein. A phase information deriving module 1004 may correspond at least in some aspects to, for example, a location determiner as discussed herein. A location condition determining module 1006 may correspond at least in some aspects to, for example, a location determiner as discussed herein. A wireless transmission controlling module 1008 may correspond at least in some aspects to, for example, an access point controller as discussed herein. A search conducting module 1010 may correspond at least in some aspects to, for example, a search controller as discussed herein. A receiving module 1102 may correspond at least in some aspects to, for example, a network interface as discussed herein. A wireless transmission controlling module 1104 may correspond at least in some aspects to, for example, an access point controller as discussed herein. A response receiving/sending module 1106 may correspond at least in some aspects to, for example, an access point controller as discussed herein. A receiving module 1202 may correspond at least in some aspects to, for example, a network interface as discussed herein. A wireless transmission controlling module 1204 may correspond at least in some aspects to, for example, a function controller as discussed herein. A response sending module 1206 may correspond at least in some aspects to, for example, a function controller as discussed herein.

The functionality of the modules of FIGS. 10-12 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. The functionality of these modules also may be implemented in some other manner as taught herein. In some aspects one or more of any dashed blocks in FIGS. 10-12 are optional.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. In addition, terminology of the form “at least one of: A, B, or C” used in the description or the claims means “A or B or C or any combination of these elements.”

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (IC), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. It should be appreciated that a computer-readable medium may be implemented in any suitable computer-program product.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. A method of communication, comprising:
receiving, at an access terminal, at least one signal from at least one access point;
deriving phase information from the at least one signal;
determining a location condition of the access terminal relative to another access point by comparing the derived phase information with phase information maintained at the access terminal; and
sending a message to a network management node to control wireless transmission at the another access point based on the determined location condition.

2. The method of claim 1, wherein:
the at least one signal comprises at least one pilot signal; and
the location condition relates to whether the access terminal is inside or outside a perimeter associated with the another access point.

3. The method of claim 2, wherein the perimeter is defined by the maintained phase information.

4. The method of claim 2, wherein the message comprises a request to enable the wireless transmission if the access terminal is inside the perimeter or to disable the wireless transmission if the access terminal is outside the perimeter.

5. The method of claim 2, wherein the message explicitly indicates whether the access terminal is inside or outside the perimeter.

6. The method of claim 1, wherein the another access point comprises a femto access point.

7. The method of claim 1, further comprising receiving a response to the message, wherein the response indicates whether the another access point has enabled the wireless transmission.

8. The method of claim 7, further comprising conducting a search for signals associated with the enabled wireless transmission as a result of the response.

9. A communication apparatus, comprising:
a receiver configured to receive, at an access terminal, at least one signal from at least one access point;
a location determiner configured to derive phase information from the at least one signal, and further configured to determine a location condition of the access terminal relative to another access point by comparing the derived phase information with phase information maintained at the access terminal; and
an access point controller configured to send a message to a network management node to control wireless transmission at the another access point based on the determined location condition.

10. The apparatus of claim 9, wherein:
the at least one signal comprises at least one pilot signal; and
the location condition relates to whether the access terminal is inside or outside a perimeter associated with the another access point.

11. The apparatus of claim 10, wherein the message comprises a request to enable the wireless transmission if the access terminal is inside the perimeter or to disable the wireless transmission if the access terminal is outside the perimeter.

12. The apparatus of claim 10, wherein the message explicitly indicates whether the access terminal is inside or outside the perimeter.

13. The apparatus of claim 9, wherein:
the receiver is further configured to receive a response to the message;
the response indicates whether the another access point has enabled the wireless transmission; and
the apparatus further comprises a search controller configured to conduct a search for signals associated with the enabled wireless transmission as a result of the response.

14. A communication apparatus, comprising:
means for receiving, at an access terminal, at least one signal from at least one access point;
means for deriving phase information from the at least one signal;
means for determining a location condition of the access terminal relative to another access point by comparing the derived phase information with phase information maintained at the access terminal; and
means for sending a message to a network management node to control wireless transmission at the another access point based on the determined location condition.

15. The apparatus of claim 14, wherein:
the at least one signal comprises at least one pilot signal; and
the location condition relates to whether the access terminal is inside or outside a perimeter associated with the another access point.

16. The apparatus of claim 15, wherein the message comprises a request to enable the wireless transmission if the access terminal is inside the perimeter or to disable the wireless transmission if the access terminal is outside the perimeter.

17. The apparatus of claim 15, wherein the message explicitly indicates whether the access terminal is inside or outside the perimeter.

18. The apparatus of claim 14, wherein:
the means for receiving is configured to receive a response to the message;
the response indicates whether the another access point has enabled the wireless transmission; and
the apparatus further comprises means for conducting a search for signals associated with the enabled wireless transmission as a result of the response.

19. A computer-program product, comprising:
computer-readable medium comprising code for causing a computer to:
receive, at an access terminal, at least one signal from at least one access point;
derive phase information from the at least one signal;
determine a location condition of the access terminal relative to another access point by comparing the derived phase information with phase information maintained at the access terminal; and
send a message to a network management node to control wireless transmission at the another access point based on the determined location condition.

20. The computer-program product of claim 19, wherein:
the at least one signal comprises at least one pilot signal; and
the location condition relates to whether the access terminal is inside or outside a perimeter associated with the another access point.

21. The computer-program product of claim 20, wherein the message comprises a request to enable the wireless transmission if the access terminal is inside the perimeter or to disable the wireless transmission if the access terminal is outside the perimeter.

22. The computer-program product of claim 20, wherein the message explicitly indicates whether the access terminal is inside or outside the perimeter.

23. The computer-program product of claim 19, wherein:
the computer-readable medium further comprises code for causing the computer to receive a response to the message;
the response indicates whether the another access point has enabled the wireless transmission; and
the computer-readable medium further comprises code for causing the computer to conduct a search for signals associated with the enabled wireless transmission as a result of the response.

24. A method of communication, comprising:
receiving a first message from an access terminal, wherein the first message is indicative of a location condition of the access terminal relative to an access point; and
sending a second message to the access point to control wireless transmission at the access point in response to the first message.

25. The method of claim 24, wherein the location condition relates to whether the access terminal is inside or outside a perimeter associated with the access point.

26. The method of claim 25, wherein the perimeter is defined by phase information maintained at the access terminal.

27. The method of claim 24, wherein the first message comprises a request to enable or disable the wireless transmission.

28. The method of claim 27, wherein the second message comprises a request to enable or disable the wireless transmission.

29. The method of claim 27, further comprising determining whether to enable or disable the wireless transmission based on the first message, wherein the second message comprises a request to enable or disable the wireless transmission.

30. The method of claim 24, wherein the first message indicates whether the access terminal is inside or outside a perimeter associated with the access point.

31. The method of claim 30, wherein the second message indicates whether the access terminal is inside or outside the perimeter.

32. The method of claim 30, further comprising determining whether to enable or disable the wireless transmission based on the first message, wherein the second message comprises a request to enable or disable the wireless transmission.

33. The method of claim 24, further comprising:
receiving at least one other message from at least one other access terminal, wherein the at least one other message is indicative of at least one location condition of the at least one other access terminal relative to the access point; and
determining whether to enable or disable the wireless transmission based on the first message and the at least one other message.

34. The method of claim 24, further comprising:
receiving a first response to the second message from the access point, wherein the first response indicates whether the access point has enabled the wireless transmission; and
sending a second response to the access terminal based on the first response.

35. The method of claim 24, further comprising determining whether to enable or disable the wireless transmission based on the first message, wherein the determination comprises determining whether to override a request to enable or disable the wireless transmission included in the first message based on a criterion specified by a network operator.

36. The method of claim 24, wherein the access point comprises a femto access point.

37. The method of claim 24, wherein an operation, administration, management, and provisioning entity receives the first message and sends the second message.

38. A communication apparatus, comprising:
a network interface configured to receive a first message from an access terminal, wherein the first message is indicative of a location condition of the access terminal relative to an access point; and
an access point controller configured to send a second message to the access point to control wireless transmission at the access point in response to the first message.

39. The apparatus of claim 38, wherein the location condition relates to whether the access terminal is inside or outside a perimeter associated with the access point.

40. The apparatus of claim 38, wherein the first message comprises a request to enable or disable the wireless transmission.

41. The apparatus of claim 40, wherein:
the access point controller is further configured to determine whether to enable or disable the wireless transmission based on the first message; and
the second message comprises a request to enable or disable the wireless transmission.

42. The apparatus of claim 38, wherein the first message indicates whether the access terminal is inside or outside a perimeter associated with the access point.

43. The apparatus of claim 42, wherein:
the access point controller is further configured to determine whether to enable or disable the wireless transmission based on the first message; and
the second message comprises a request to enable or disable the wireless transmission.

44. A communication apparatus, comprising:
means for receiving a first message from an access terminal, wherein the first message is indicative of a location condition of the access terminal relative to an access point; and
means for sending a second message to the access point to control wireless transmission at the access point in response to the first message.

45. The apparatus of claim 44, wherein the location condition relates to whether the access terminal is inside or outside a perimeter associated with the access point.

46. The apparatus of claim 44, wherein the first message comprises a request to enable or disable the wireless transmission.

47. The apparatus of claim 46, wherein:
the means for sending is configured to determine whether to enable or disable the wireless transmission based on the first message; and
the second message comprises a request to enable or disable the wireless transmission.

48. The apparatus of claim 44, wherein the first message indicates whether the access terminal is inside or outside a perimeter associated with the access point.

49. The apparatus of claim 48, wherein:
the means for sending is configured to determine whether to enable or disable the wireless transmission based on the first message; and
the second message comprises a request to enable or disable the wireless transmission.

50. A computer-program product, comprising:
computer-readable medium comprising code for causing a computer to:
receive a first message from an access terminal, wherein the first message is indicative of a location condition of the access terminal relative to an access point; and
send a second message to the access point to control wireless transmission at the access point in response to the first message.

51. The computer-program product of claim 50, wherein the location condition relates to whether the access terminal is inside or outside a perimeter associated with the access point.

52. The computer-program product of claim 50, wherein the first message comprises a request to enable or disable the wireless transmission.

53. The computer-program product of claim 52, wherein:
the computer-readable medium further comprises code for causing the computer to determine whether to enable or disable the wireless transmission based on the first message; and
the second message comprises a request to enable or disable the wireless transmission.

54. The computer-program product of claim 50, wherein the first message indicates whether the access terminal is inside or outside a perimeter associated with the access point.

55. The computer-program product of claim 54, wherein:
the computer-readable medium further comprises code for causing the computer to determine whether to enable or disable the wireless transmission based on the first message; and
the second message comprises a request to enable or disable the wireless transmission.

56. A method of communication, comprising:
receiving, at an access point, a message from a network management node, wherein the message is indicative of a location condition of an access terminal relative to the access point; and
controlling wireless transmission at the access point based on the message.

57. The method of claim 56, wherein the location condition relates to whether the access terminal is inside or outside a perimeter associated with the access point.

58. The method of claim 57, wherein the perimeter is defined by phase information maintained at the access terminal.

59. The method of claim 56, wherein the message comprises a request to enable or disable the wireless transmission.

60. The method of claim 56, wherein the message indicates whether the access terminal is inside or outside a perimeter associated with the access point.

61. The method of claim 56, further comprising receiving at least one other message from the network management node, wherein:
the at least one other message is indicative of at least one location condition of at least one other access terminal relative to the access point; and
the controlling of the wireless transmission is further based on the at least one other message.

62. The method of claim 56, further comprising sending a response to the network management node, wherein the response indicates whether the access point has enabled the wireless transmission.

63. The method of claim 56, wherein the access point comprises a femto access point.

64. The method of claim 56, wherein the controlling of the wireless transmission comprises enabling or disabling at least one component of a transceiver of the access point.

65. The method of claim 56, wherein the controlling of the wireless transmission comprises enabling or disabling wireless protocol operations of the access point.

66. A communication apparatus, comprising:
a network interface configured to receive, at an access point, a message from a network management node, wherein the message is indicative of a location condition of an access terminal relative to the access point; and
a function controller configured to control wireless transmission at the access point based on the message.

67. The apparatus of claim 66, wherein the location condition relates to whether the access terminal is inside or outside a perimeter associated with the access point.

68. The apparatus of claim 66, wherein the message comprises a request to enable or disable the wireless transmission.

69. The apparatus of claim 66, wherein the message indicates whether the access terminal is inside or outside a perimeter associated with the access point.

70. The apparatus of claim 66, wherein:
the function controller is further configured to send a response to the network management node; and
the response indicates whether the access point has enabled the wireless transmission.

71. A communication apparatus, comprising:
means for receiving, at an access point, a message from a network management node, wherein the message is indicative of a location condition of an access terminal relative to the access point; and
means for controlling wireless transmission at the access point based on the message.

72. The apparatus of claim 71, wherein the location condition relates to whether the access terminal is inside or outside a perimeter associated with the access point.

73. The apparatus of claim 71, wherein the message comprises a request to enable or disable the wireless transmission.

74. The apparatus of claim 71, wherein the message indicates whether the access terminal is inside or outside a perimeter associated with the access point.

75. The apparatus of claim 71, wherein:
the means for controlling is configured to send a response to the network management node; and
the response indicates whether the access point has enabled the wireless transmission.

76. A computer-program product, comprising:
computer-readable medium comprising code for causing a computer to:
receive, at an access point, a message from a network management node, wherein the message is indicative of a location condition of an access terminal relative to the access point; and
control wireless transmission at the access point based on the message.

77. The computer-program product of claim 76, wherein the location condition relates to whether the access terminal is inside or outside a perimeter associated with the access point.

78. The computer-program product of claim 76, wherein the message comprises a request to enable or disable the wireless transmission.

79. The computer-program product of claim 76, wherein the message indicates whether the access terminal is inside or outside a perimeter associated with the access point.

80. The computer-program product of claim 76, wherein:
the computer-readable medium further comprises code for causing the computer to send a response to the network management node; and
the response indicates whether the access point has enabled the wireless transmission.
